(19) United States
(12) Patent Application Publication
(10) Pub. No.: US 2024/0348134 A1
(43) Pub. Date: Oct. 17, 2024

(54) METHOD FOR PRODUCING A ROTOR FOR AN ELECTRIC MACHINE, IN PARTICULAR FOR AN AXIAL FLUX MACHINE

(71) Applicant: MERCEDES-BENZ GROUP AG, Stuttgart (DE)

(72) Inventors: Mike FUCHSLOCHER, Stuttgart (DE); Tim ZIEGLER, Tamm (DE); Thomas ALBRECHT, Memmingerberg (DE); Cornelius HENTRICH, Waiblingen (DE); Maximilian WENZEL, Esslingen (DE); Holger BOMMER, Esslingen (DE)

(21) Appl. No.: 18/580,327

(22) PCT Filed: Jul. 15, 2022
(86) PCT No.: PCT/EP2022/069863

§ 371 Date: Jan. 18, 2024

(30) Foreign Application Priority Data
Jul. 19, 2021 (DE) 10 2021 003 706.5

(51) Int. Cl. H02K 15/03; H02K 1/2795

(52) U.S. Cl. CPC H02K 15/03; H02K 1/2795

(57) ABSTRACT

A rotor for an electric machine is produced using a band provided with through openings, which is then is wound up in such a manner that each longitudinal region of the band forms layers arranged one on top of the other in the radial direction of the rotor and the through openings are arranged one on top of the other in the radial direction of the rotor. This forms receptacle openings widening outwards in the radial direction of the rotor, are spaced apart from each other in succession in the circumferential direction of the rotor, and in which magnets are arranged.

### BACKGROUND AND SUMMARY OF THE INVENTION

Exemplary embodiments of the invention are directed to a method for producing a rotor for an electric machine, in particular for an axial flux machine.

DE 10 2007 019 911 A1 describes a method for producing sheet metal parts, in particular electrical sheet metal parts, by cutting sheet metal. WO 2018/015293 A1 discloses a stator for an axial flux machine and a method for producing such a stator. An axial flux machine is known from EP 2 355 313 A1. US 2010/0090555 A1 likewise discloses an axial flux machine. Furthermore, an axial flux machine is known from WO 2016/113567 A1.

Exemplary embodiments of the present invention are directed to a method, by means of which a rotor for an electric machine, in particular for an axial flux machine, can be produced in a particularly time- and cost-effective manner.

The invention is concerned with a method for producing a rotor for an electric machine, in particular for an axial flux machine. Preferably, the electric machine is used in or for a motor vehicle, in particular in or for a motor car, in particular as a traction machine, by means of which the motor vehicle can be driven, in particular purely, electrically. Preferably the electric machine is formed as a high-voltage component, whose electrical voltage, in particular electrical operating voltage or rated voltage, is preferably greater than 50 volts, in particular greater than 60 volts, and amounts very preferably to several hundred volts. Therefore, particularly great electrical power for the, in particular purely, electrical driving of the motor vehicle can be achieved. In its completely produced state, the axial flux machine has at least one stator and at least one rotor in the form of the aforementioned rotor, wherein the stator and the rotor are arranged one after the other or next to each other or behind each other in the axial direction of the axial flux machine, in particular in such a way that an air gap is arranged in the axial direction of the axial flux machine between the rotor and the stator. The rotor can be driven by means of the stator and can therefore be rotated relative to the stator about an axis of rotation running in the axial direction of the axial flux machine, so that the axial flux machine (electric machine) can provide torques via its rotor for electrically driving the motor vehicle, in particular purely electrically.

In the method, a band is provided with through openings that are spaced apart and separated from one another, in particular, in the longitudinal direction of the band, and is then wound up, in particular to form a coil, in such a manner that each longitudinal region of the band forms layers arranged one on top of the other in the radial direction of the rotor, and thus in succession, and that the through openings, which are preferably separated from one another in succession in the circumferential direction of the rotor extending around the axial direction of the rotor when the band is wound up to form the coil, are arranged one on top of the other in the radial direction of the rotor, thereby forming receptacle openings that widen outwards in the radial direction of the rotor, in particular in a funnel-like or funnel-shaped or wedge-shaped manner, and follow one another in the circumferential direction of the rotor extending around the axial direction of the rotor and are spaced apart from one another, and thus separated from one another, in particular by respective wall regions of the band. Magnets, in particular permanent magnets, are arranged in the receptacle openings.

Preferably, the band is made of a metallic material, in particular of sheet metal and, in particular, of rotor core laminations, so that the wound coil, also known as the rotor unit, can particularly advantageously guide a magnetic flux or a respective magnetic field that can be provided or is provided by the respective magnet. In particular it can be provided that the band is at least wound up and provided in one, in particular a single, step. This may be understood to mean the following in particular: While, for example, a first section of the band already provided with the first of the through openings is wound up, in particular in the axial direction of the rotor, the band is provided with at least one second one of the through openings or with several second ones of the through openings in a second section of the band that has not yet been wound up, and thus at least one second or several second ones of the through openings is produced in the second section of the band. The second section is then also wound up, in particular onto or around the first section that has already been wound up. For example, the respective through openings are produced by punching or by a punching method. Furthermore, it is conceivable that at least one of the magnets is arranged in at least one of the receptacle openings whilst the band is wound up, wherein the at least one receptacle opening is, for example, already produced or formed, and/or, for example, another one of the receptacle openings is still being or not yet formed, in particular by winding up the band.

For example, the respective through opening itself, i.e., viewed on its own in the circumferential direction of the respective through-opening, is formed completely circumferentially by the band, i.e., by a respective wall region of the band. The feature that the respective receptacle opening widens outwards in the radial direction of the rotor and that the receptacle openings are formed by the through-openings of the band is to be understood in particular as follows: A first of the receptacle openings, also referred to as magnet pockets or pockets, is formed, for example, by a first group of the through openings formed by first through openings, and a second of the receptacle openings is formed, for example, by a second group of the through openings formed through openings. The first through openings of the first group are arranged one above the other in the radial direction of the rotor, i.e., one on top of the other, and the second through openings of the second group are arranged one above the other or one on top of the other in the radial direction of the rotor, i.e., one after the other. This means that the respective through openings of the respective group overlap each other at least partially in the radial direction of the rotor, in particular at least predominantly and thus at least more than half or completely. The respective through opening of the respective group has, for example, a respective length and a respective width. The respective width extends, for example, in the wound-up state of the band in the circumferential direction of the rotor. The respective width extends, for example, in the axial direction of the rotor. It is, in particular, provided that the through openings of the respective group differ from each other in their width and/or length. In particular, it can be provided that the through openings of the respective group differ from each other in their respective length, while, for example, the through openings of the respective group have the same width. In particular, it is provided that the lengths in the radial direction of the rotor become greater towards the outside, i.e., increase, so that the through openings of the respective group become larger with regard to their lengths in the radial direction of the rotor when viewed from the outside.

In order to be able to produce the rotor in a particularly time- and cost-effective manner, it is provided in one embodiment of the invention that between the winding up of the band, in particular to form the coil, and the arrangement of the magnets in the receptacle openings, there is no unwinding of the band, in particular wound-up to form the coil, and no subsequent rewinding of the band. This means that a coiling unit comprising at least the coil and the magnets arranged in the pockets can be produced in a single process or work step, so that the rotor can be produced particularly quickly and cost-effectively.

A further embodiment is characterized in that, the longitudinal regions and therefore the layers are formed with each other as one piece. This means that at least the longitudinal regions and thus the layers are formed by the band formed one piece and, for example, as a metal band, whereby the coiling unit and thus the rotor can be produced particularly quickly and cost effectively. For example, the band, in particular as an endless material, is provided wound up into an output coil, such that the output coil, which is also referred to as a coil, is provided. The output coil is unwound. In other words, the band is unwound from the output coil, after which the band is provided with the through openings, i.e., the through openings are introduced into the band. It is preferable in this case that the band is not wound up and unwound again between the unwinding of the band from the output coil and the provision of the band with the through openings. The rotor can be produced particularly quickly and cost-effectively by providing the output coil, subsequently unwinding the band, providing the band with the through holes and then winding the band up into the coil.

In a further, particularly advantageous embodiment of the invention, it is provided that the band is moved translationally along a conveying direction at least substantially continuously, i.e., without interruption, while the band is being provided with the through openings and is conveyed thereby. As a result, the coiling unit can be produced at least substantially continually, i.e., without excessive interruptions, such that it can be produced particularly quickly and cost-effectively.

In a further, particularly advantageous embodiment of the invention, it is provided that the through openings are produced by nibbling, which is also referred to as nibble cutting. This means that the, or all, through openings, i.e., the differently sized through openings, can be produced using one and the same tool, in particular a cutting or punching tool. In other words, different, i.e., differently sized, punching tools or punching templates are not required to produce the differently sized through openings, so that the rotor can be produced particularly cost-effectively.

The fact that the aforementioned coil unit comprises the coil, i.e., the band wound up with the coil in particular, and the magnets arranged in the receptacle openings (magnet pockets) means that the magnets are integrated into the coil, so to speak. As, for example, the band and thus the coil are formed from a metal sheet, in particular from an electric metal sheet, the wound-up band, i.e., the coil, forms, for example, a laminated core in which the magnets are integrated. Thus, the method makes it possible to produce the laminated core with the integrated magnets in a particularly time- and cost-effective manner.

In an advantageous development of the invention, the sheet metal layers are inductively bonded in-line after manufacturing the receptacle openings for the magnets. This makes handling easier when inserting the magnets and the bonded sheet metal layers are already stable. Bonding can also be carried out in other ways, but inductive bonding has proven to be easy to use. In-line bonding means that although the bonding process step is carried out separately, this is done directly after the previous process step and therefore without interrupting the overall process with other measures. In addition, the bonding can advantageously take place directly in the apparatus for winding as a coil, so that the wound coil is bonded directly without having to remove it from the apparatus and possibly having to stabilize it temporarily. A coil bonded in such a way can then easily processed further processing or temporarily stored. When bonding in-line in the apparatus for the winding up, the bonding process step can also be carried out between different production steps, without preventing them from taking place, but rather delaying them as much as possible. In this way, part of the coil can be wound up, in particular until completion of the magnet receptacle opening, and this intermediate product, which can be wound up even further, can then simply be bonded in advance without preventing further winding. In such a case, for example, winding can be continued after the magnets have been inserted and even more layers of the band can be wound radially outside the receptacle opening and the magnets. These layers can then be fixed, in particular bonded again, which would then also correspond to the process step of in-line inductive bonding.

In order to be able to arrange the magnets in the magnet pockets in a particularly simple and thus time- and cost-effective manner and thus to be able to produce them in the rotor in a particularly simple, time- and cost-effective manner, it is provided in a further embodiment of the invention that each magnet is arranged in the respective receptacle opening at least partially, in particular at least predominantly and thus more than half or completely, in such a way that each magnet is moved in the radial direction of the rotor and thus in the radial direction of the coil from the outside to the inside in relation to the layers and is thus moved into the respective receptacle opening. This means that excessively complex shapes of the respective pocket can be avoided, in particular in that the pocket is only open in the radial direction of the rotor pointing outwards in order to move the magnet into the pocket. Other openings or a geometrically complex opening in order to be able to arrange the respective magnet in the respective pocket can be avoided, so that a particularly simple and therefore time- and cost-saving construction of the coil can be guaranteed. Furthermore, steps that follow the arrangement of the respective magnet in the respective receptacle opening and are provided, for example, in order to close the respective pocket, can be avoided or their number and/or complexity can be kept particularly low, so that the rotor can be produced particularly simply and cost-effectively.

In order to be able to guarantee a particularly good hold of the respective magnet in the respective magnet pocket (receptacle opening) in a particularly simple and cost-effective manner, it is provided in a further embodiment of the invention that after it has been arranged in the respective receptacle opening, each magnet is connected to the band by means of a plastic which is injection-molded onto the band, and thus onto the coil and the respective magnet. For example, the plastic is injected into the respective magnet pocket and therefore injection-molded onto the respective magnet and the wound-up band, i.e., the coil. For example, the plastic is injected into the respective pocket in the radial direction of the rotor from the outside inwards or from the inside outwards, whereby the respective magnet can be connected to the coil in a particularly simple way and particularly firmly. In particular, after the plastic has been injection-molded onto the coil and the respective magnet, the plastic hardens, whereby the respective magnet is held particularly firmly on the coil.

A further embodiment is characterized in that the receptacle openings are sealed at least partially, in particular at least predominantly and thus to more than half or completely, in the radial direction of the rotor towards the inside by means of a, in particular first, top layer. Alternatively, or in addition it is provided that the receptacle openings are sealed at least partially, in particular at least predominantly or completely, in the radial direction of the rotor towards the outside by means of at least one, in particular second, top layer. This is a particularly simple way of ensuring that the respective magnet is held particularly firmly on the coil.

The receptacle openings are at least partially sealed, for example, in the radial direction of the rotor and thus of the coil towards the inside by means of the, in particular first, top layer, in such a way that the band is wound up onto the first top layer during winding, i.e., is wound around the first top layer. Therefore, the rotor can be produced particularly simply. Furthermore, it is conceivable that the receptacle openings are at least partially sealed In the radial direction of the rotor and thus of the coil towards the outside, for example by means of the, in particular second, top layer, in such a way that the second top layer is wound onto the coil and thereby wrapped around the coil and the magnets arranged in the magnet pockets, in particular after the band has been wound up to form the coil. Thus, it is conceivable, for example, that the first top layer adjoins the coil or the magnets on the inside in the radial direction of the rotor and thus of the coil and/or the second top layer adjoins the coil or the magnets on the outside in the radial direction of the rotor and thus of the coil. This means that the rotor can be produced particularly easily and therefore quickly and cost-effectively, and it is also possible to prevent the magnets from moving out of the magnet pockets in an undesirable manner even at very high rotor speeds.

It is conceivable that the respective top layer is formed separate from the coil and thus separate from the longitudinal regions and the layers, also referred to as plies.

In order to be able to keep the costs of the rotor particularly low, it is provided in a further embodiment of the invention that the top layer, in particular the respective top layer, is formed as one piece. The top layer could be formed from a plastic. However, it is advantageous if the top layer is formed from a metallic material, in particular from the metallic material from which the band is formed. Thus, the top layer can be made of an electrical steel sheet or from the electrical steel sheet.

In further, particularly advantageous embodiment of the invention, the top layer is formed as one piece with the layers. In other words, the top layer is, for example, formed as one piece with the longitudinal regions. Thus, it is provided, for example, that the top layer is not provided with through openings. In particular, the top layer is not provided with such through openings that completely overlap the through openings forming the magnet pockets such that, the top layer can seal the magnet pockets particularly advantageously, at least partially. For example, in order to produce the first top layer as a top layer formed in one piece with the longitudinal regions, a first part of the band is, for example, first wound up, whereby the first part forms the top layer and is therefore free of through openings, for example. At least the first top layer or the first part is free of such through openings into which the magnets arranged in the magnet pockets can slide inwards in a radial direction. The band is then wound up and wrapped around the top layer, for example, in such a way that the longitudinal regions form the layers and the through openings with which the longitudinal regions are provided form the magnet pockets. The magnets are then arranged in the magnet pockets. Then, for example, a second part of the band, forming the second, outer top layer, is wound up and thus wound around the coil or the longitudinal regions, the magnet pockets, and the magnets, whereby, for example, the second part is not provided with through openings or at least not with such through openings which are larger than the through openings forming the magnet pockets, or into which the magnets can be slid in the radial direction outwards. It is conceivable in each case that the first part and/or the second part, i.e., the first top layer and/or the second top layer, is formed in one piece with the longitudinal regions forming the layers.

In order to be able to at least partially seal each of the magnet pockets in particular as needed and particularly cost-effectively, it is provided in a further embodiment of the invention that the top layer is formed by a band element formed separately from the layers and thus separately from the longitudinal regions. For example, the top layer is provided separately from the longitudinal regions and thus separately from the layers, after which, for example, the band or longitudinal regions are wound around the top layer or the top layer is wound around the longitudinal regions. For example, it is conceivable that the band element is separated from the band and subsequently used as the top layer, which is formed separate from the layers, in the completely produced state of the rotor.

The invention is based, in particular, on the following findings: in order to achieve an optimized utilization of a surface or a particularly high torque and power density of the electric machine, a design that covers the surface as extensively as possible, in particular almost completely, with magnets is desirable. Due to a possible disc-shaped arrangement, in particular of the rotor and especially in relation to the stator, it has proven to be advantageous to allow the magnet pockets to become larger in the radial direction of the rotor towards the outside, in particular continuously. However, in order to realize this by arranging layers or plies in succession in the radial direction of the rotor, a large number of different, i.e., differently sized, punches may be required. This can lead to complex and cost-intensive production, but can be avoided by producing the through openings by nibbling. The nibbling enables superimposed cutting of the pockets in order to achieve the different sizes, in particular the different aforementioned lengths, by means of in particular exactly one tool. In addition, edge areas of the coil, i.e., of the electrical steel sheet, can be cut off and/or trimmed. This improves tolerances and reduces losses, in comparison to common solutions.

In order to be able to produce the rotor in a particularly time- and cost-effective manner, it is preferable that the pockets and the lateral trim are produced by high-speed shearing, i.e., that the band is provided with the through openings by high-speed shearing. By using high-speed technology to produce the through openings by high-speed shearing, the residual stress can be kept particularly low, and the remagnetization losses in cutting edges can also be kept particularly low.

For example, the band is provided by means of a tool, by means of which, for example, the nibbling is carried out. A variable feeding unit, for example, located in particular upstream of the tool, enables high-precision alignment and arrangement of the through openings and thus the pockets. For example, the band is moved translationally and thus conveyed by means of the feeding unit.

The invention also makes it possible to produce the coil and thus the rotor core in a particularly time- and cost-effective manner, as the use of impregnating resin can be avoided by the subsequent in-line process of stacked lamination with, for example, self-bonding varnish or the adhesive, which is also simply referred to as glue. Furthermore, in contrast to providing the layers with the impregnating resin on all sides, it is possible to arrange the bonding agent only in the radial direction between the layers (sheets), so that it is preferably provided that the bonding agent is arranged exclusively on the respective broad sides of the layers, i.e. exclusively in the radial direction between the layers. Machining is thus not absolutely necessary, and in comparison to conventional solutions, residual dirt can be reduced.

The invention enables at least the following advantages to be achieved:
High integration (magnet, coil, or laminated core, radial and circumferential magnet support);
Elimination of components and processes compared to conventional solutions, especially in the case of gluing on magnets, reduction of handling effort, and cost reduction;
Additional amount of reluctance due to the magnets, which are buried magnets because they are arranged in the magnet pockets;
Lifetime-safe integration of the magnets, in particular through mechanical support of centrifugal forces in the coil by means of the top layer, also known as the bandage, and in particular without ageing effects as is the case with adhesives;
Compared to conventional solutions: Reduction of a tolerance chain and improvement of balancing quality through precise alignment of the magnets relative to each other;
Compared to conventional solutions: improved thermal connection of the magnets, in particular onto the coil and/or due to elimination of contact resistances; and
Reduced risk of short-circuiting and thus higher burr efficiency due to reduced burr from layer to layer without re-trimming the band edges.

Overall, it can be seen that in the method according to the invention, the winding of the band to form the coil, also known as coiling, and the providing of the band with the through openings, for example by punching, take place in one, in particular single, step, whereby simultaneous arrangement or insertion of the magnets in the pocket or pockets is conceivable. This means, in particular, that, for example, at least one of the magnets is produced in one of the pockets while, for example, at least one of the through openings is being produced and/or while at least one of the through openings has not yet been produced.

For example, the first top layer is first rolled or wound as a continuous, inner layer, for example. It is also conceivable to use two or more first, inner top layers. The longitudinal regions are then provided with the through openings and wound up, in particular in such a way that the longitudinal regions are wound around the first top layer or wound onto the first top layer in such a way that the through openings of the longitudinal regions form the magnet pockets and the magnet pockets are at least partially sealed inwards in a radial direction by the first, inner top layer. In particular, the band is wound up for so long that the longitudinal regions are arranged on top of each other in the radial direction of the rotor, thus forming such a number of layers arranged on top of each other, until a predetermined or predeterminable height of the receptacle openings extending in the radial direction of the rotor is reached. Then, for example, the magnets are arranged in the pockets, in particular inserted into the pockets, which, for example, are conical or triangular. The second, outer top layer is then wrapped around the longitudinal regions, i.e., around the layers, the magnet pockets, and the magnets, in particular as an outer layer, wherein it is conceivable to use two or more second, outer top layers. The outer top layer is wrapped around the layers, magnet pockets, and magnets arranged therein in such a way that the magnet pockets are at least partially sealed in a radial direction towards the outside by the outer, second top layer. As previously mentioned, it is conceivable that the first, inner top layer and/or the outer, second top layer is formed in one piece with the longitudinal regions having the through openings.

Due to the invention, the magnets can be easily and safely inserted into the magnet pockets. Furthermore, the magnets can also be well secured during operation of the electric machine by the respective top layer, which functions or is designed as a bandage. In addition, the magnets can be adhesively bonded to the coil from the inside, for example. For example, by introducing the plastic, which acts in particular as an adhesive, into the magnet pockets, the magnets can be moved, for example, in a radial direction from the inside to the outside, in particular by introducing the plastic, in particular in liquid form, into the magnet pockets in a radial direction from the inside to the outside, in particular by injecting it. For example, the first, inner top layer, in particular for each magnet pocket, has at least one injection opening designed as a further through opening, which overlaps or covers the respective magnet pocket. In other words, the injection opening opens into the respective magnet pocket, for example, so that the plastic, in particular in the liquid state of the plastic, can be injected through the injection opening and thereby injected into the respective magnet pocket via the respective injection opening. Therefore, the plastic can be injection-molded onto the coil and magnets arranged in the respective magnet pockets in order to adhesively bond the respective magnets with the coil, i.e., with the band. The plastic is then used as a potting compound in order to fix the magnets firmly onto the coil.

The invention also includes a rotor produced using the method according to the invention. Advantages and advantageous embodiments of the method according to the invention are to be regarded as advantages and advantageous embodiments of the rotor and vice-versa.

The invention also includes an apparatus for carrying out the method according to the invention. Advantages and advantageous embodiments of the method according to the invention are to be regarded as advantages and advantageous embodiments of the apparatus and vice-versa.

Since, for example, in the finished state of the rotor, the longitudinal regions with the through openings forming the magnet pockets are arranged in a radial direction between the first, inner top layer and the outer, second top layer, the layers are also referred to as inner or middle layers, with the top layers being referred to as inner or outer top layers, for example. For example, the inner top layer and/or the outer top layer are not punched. For example, while the inner layers are used to form the magnet pockets, the inner top layer and the outer top layer are used to close the magnet pockets radially inwards and outwards, in particular to at least partially seal the magnet pockets radially inwards and outwards, and thus ensure that the magnets are held securely on the coil, i.e., on the inner layers. A number of inner layers, a number of inner top layers and a number of outer top layers can depend on parameters, in particular radial parameters, of the rotor and/or the magnet pockets, so that more than one inner top layer and/or more than one outer top layer can be provided.

As already indicated above, the first, inner top layer and/or the outer, second top layer can be formed separately from the inner layers, which are preferably formed in one piece with each other. Furthermore, it is conceivable that the inner top layers are formed from a first material, in particular from a first electric metal sheet, wherein the first, inner top layer and/or the second, outer top layer can be formed from a respective second material that is different from the first material, in particular a second electric metal sheet. For example, the first, inner top layer is then wound first, after which the band is wound onto the first top layer, thereby forming the middle layers to form the magnet pockets. The outer, second top layer is then produced, for example, in particular by winding the second, outer top layer onto the inner layers, i.e., wrapping it around the inner layers. For example, the first top layer is thus made from a first sheet metal band, the inner layers from a second sheet metal band, and the outer top layer from a third sheet metal band. It is conceivable that respective transitions and/or ends of the band are joined and/or subsequently fixed to the respective transitions or ends of the top layers. The advantage here is that different materials can be used for the top layers and the band or the layers forming the magnet pockets, and thus different material properties can be utilized. It is therefore conceivable, for example, to make the inner top layer and/or the outer top layer thicker and/or more stable than the inner layers, i.e. than the band forming the inner layers and thus the coil.

It is further possible to carry out the invention, in particular after arranging the magnets in the magnet pockets and, in particular after wrapping the second, outer top layer around the layers, a so-called negative balancing, in particular by performing separating machining, in particular punching and/or nibbling, on at least one of the layers and/or the outer top layer and/or inner top layer. In other words, for example, the second, outer top layer (bandage) can be machined or separated, in particular by nibbling, whereby negative balancing can be carried out, by means of which the rotor is balanced. This makes it possible to realize particularly smooth running of the rotor in a particularly simple and cost-effective way.

It is also conceivable in the method that at least one or more further free spaces and/or at least one or more channels can be formed in the layers, for example in the form of sheet metal layers, in particular punched into the layers. For example, the band and thus the layers are provided with passage openings that are completely closed in the circumferential direction, for example, which then overlap or cover each other, for example when the band is wound up, and thus interact and thus form the aforementioned at least one free space or channel, whereby, for example, the free space or channel can be flowed through by a temperature control medium, in particular a liquid or gaseous medium, for temperature control, i.e., for cooling and/or heating the rotor. This allows a different temperature control of the coil (laminated core) to be realized, as the free space or channel runs inside the coil. Thus, the passage openings are provided in addition to the through openings and are separated from the through openings, so that the free space or channel in front of the magnet pockets is preferably separated, in particular fluidically. Therefore, effective and efficient temperature control of the rotor can be achieved.

In particular, if the magnets are connected, in particular adhesively bonded, to the band and thus to the coil, the inner, first top layer and/or the second, outer top layer (bandage) could be dispensed with, for example, or the number of inner top layers and/or other top layers can be kept particularly low, since the plastic acting as an adhesive or grout ensures a particularly strong, in particular material-locking connection between the magnets and the coil. The respective top layer has the advantage that it forms a solid stop for the magnets, i.e., a solid body, especially when the magnets are glued together, whereby unwanted relative movements between the magnets and the band or coil can be avoided. If, for example, the inner and/or outer top layer is dispensed with, the negative balancing described above cannot, for example, take place on the inner or outer top layer, but the negative balancing can then take place, for example, on at least one of the layers forming the magnet pockets and, for example, between the magnet pockets. In particular, balancing can be carried out at several points, for example at a distance from each other, for example on both sides of at least one of the magnet pockets.

As described above, the through openings for forming the magnet pockets are made before the band is wound up to form the coil. However, it is conceivable that the through openings for forming the magnet pockets could be made after direct winding or directly after winding up the band, in particular in such a way that the respective magnet pocket is punched into the wound band, whereupon, for example, punching waste should be removed. However, the advantage of the method according to the invention, in which the band is first provided with the through openings and then wound up, is that any waste resulting from the production of the through openings is particularly simple or does not have to be removed separately, which means that the rotor can be produced particularly quickly and cost-effectively.

The through openings in the band are created, for example, by punching, which can be done in several ways. For example, the growing, i.e., outwardly increasing through openings or magnet pockets in the radial direction of the rotor can be punched to accommodate the preferably conical magnets by repeated punching with fixed punching molds and partial overlapping, or a variable punching geometry can also be used, which can form the growing magnet pockets in one punching step. It is preferably provided that the respective magnet has a respective outer form which is matched to a respective inner form of the respective magnet pocket, in which the respective magnet is arranged. Thus, it is preferably provided that the respective magnet that is or will be arranged in the respective magnet pocket also widens outwards in the radial direction of the rotor, in particular in a conical or wedge-shaped manner. It is also conceivable that the respective through openings are produced by a removal method such as nibbling, milling, chipping, cutting, etc., whereby the band or the respective layer is machined accordingly in order to produce the respective through opening.

Since, for example, the respective magnet pocket and the respective magnet to be arranged or arranged in the respective magnet pocket are conical or triangular in shape, the respective magnet pocket and the respective associated magnet widen outwards with increasing radial position, i.e., outwards in the radial direction of the rotor, which may need to be taken into account during production, as well as the covering or overlapping arrangement of the through openings in relation to each other when the band is wound up. For example, a web, in particular in the circumferential direction of the rotor running around the axial direction of the rotor, can be arranged between the respective through openings or magnet pockets and thus remain in place, whereby the web always has the same width, for example, in particular in the circumferential direction of the rotor. It is therefore conceivable that respective sides of the respective magnet pocket or of the respective magnet later run parallel to each other, or the width can constantly increase or decrease, such that an area between the magnet pockets does not have a constant width in the radial direction either and is therefore also conical. In other words, it is conceivable that, as an alternative or in addition to the lengths of the through openings, the widths of the through openings in the radial direction of the rotor become larger towards the outside, i.e., increase.

Further advantages, features and details of the invention result from the description of preferred exemplary embodiments below, as well as by means of the drawing. The features and feature combinations referred to above in the description as well as the features and feature combinations referred to below in the description of the figures and/or shown solely in the figures can be used not only in each specified combination but also in other combinations or alone without leaving the scope of the invention.

### BRIEF DESCRIPTION OF THE DRAWINGS

In the drawing is shown:

FIG. 1 a schematic depiction of a first embodiment of an inner, first top layer of a rotor for an electric machine formed as an axial flux machine;

FIG. 2 a schematic perspective view of a coil of the rotor wound up onto the first top layer according to FIG. 1 and thus wound around the first top layer;

FIG. 3 a partial schematic and unwound view of the coil according to FIG. 2;

FIG. 4 a further schematic perspective view of the coil according to FIG. 2;

FIG. 5 a schematic perspective view of a first embodiment of a coiling unit which comprises the coil according to FIG. 2;

FIG. 6 a schematic and perspective sectional view of the first embodiment of the coiling unit;

FIG. 7 a schematic side view of an apparatus for performing the method;

FIG. 8 a schematic perspective view of a second embodiment of the inner first top layer;

FIG. 9 a schematic and perspective sectional view of a second embodiment of the coiling unit which comprises the coil according to FIG. 8;

FIG. 10 a partial schematic and perspective sectional view of a third embodiment of the coiling unit; and

FIG. 11 a partial schematic and perspective sectional view of a fourth embodiment of the coiling unit.

In the figures, identical or functionally identical elements are provided with the same reference numerals.

### DETAILED DESCRIPTION

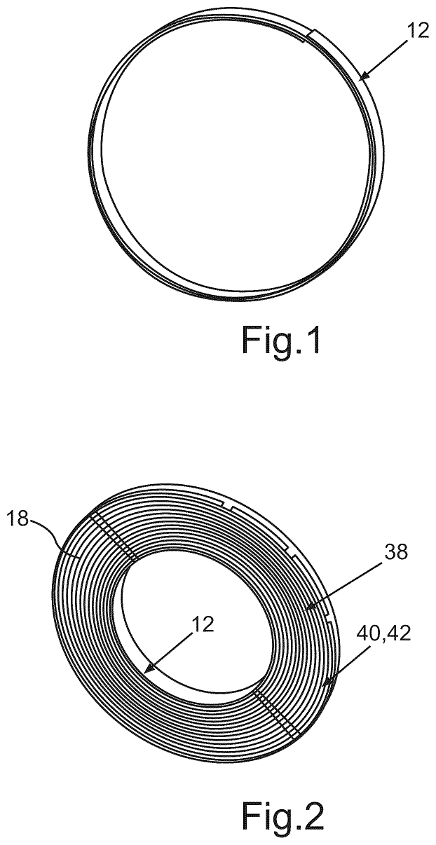

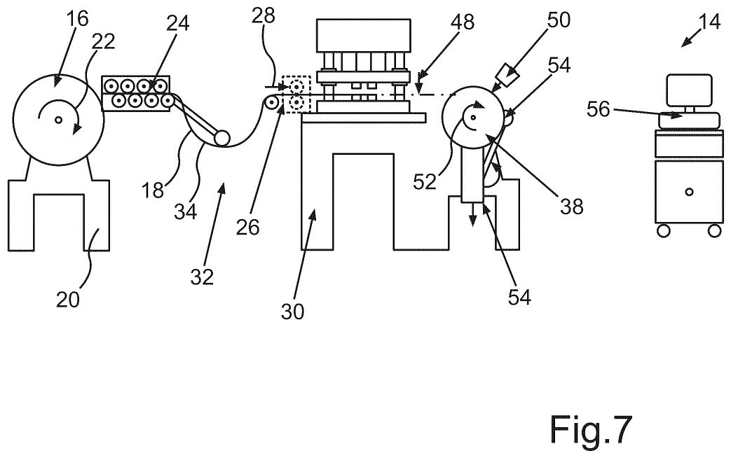

In the following, a method for producing a rotor 10 (FIG. 5) for an electric machine, formed as an axial flux machine, of a motor vehicle, is described according to the figures. This means that the axial flux machine is used as a traction machine for a, or in, a motor vehicle, such that the motor vehicle has the axial flux machine in its completely produced state and is drivable in particular in a purely electric manner, by means of the axial flux machine. Therefore, the motor vehicle is preferably an electric vehicle, in particular a battery electric vehicle. A first embodiment of the method is described based on FIGS. 1 to 6. FIG. 1 illustrates a first embodiment of a first, inner top layer 12 of the rotor 10, in a schematic perspective view. FIG. 7 exhibits an apparatus 14 for performing the method, i.e., for producing the rotor 10. As can be seen from FIG. 7, an output coil 16, also referred to as a coil, of a band 18 is provided. This means that the band 18 is initially wound up to form the output coil 16. The output coil 16 is held on a reel 20 and—as illustrated by an arrow 22—is rotated around a rotational axis, in particular in relation to the reel 20, and thereby unwound, i.e., uncoiled. This is to be understood to mean, in particular, that the band 18 is unwound from the output coil 16. The band 18 is unwound from the output coil 16 and fed into a straightener device 24, by means of which the band 18 is straightened, i.e., aligned. The apparatus 14 comprising the reel 20 and the straightener device 24, further comprises a form thrust unit 26, also referred to as a conveying device, by means of which the band 18 is moved, and thus conveyed, translationally along a feed direction, illustrated by an arrow 28 in FIG. 7, in particular in relation to a tool 30 formed, for example, as a punch unit or punch tool. After the straightener device 24 and before the feeding unit 26, a so-called buffering of the band 18 takes place in a buffer region 32. The buffering comprises, in particular, that a strap 34 of the band 18 is formed, in particular specifically formed, in the buffer region 32, for example to decouple the straightener device 24 or the straightening of the band 18 caused by means of the straightener device 24 from the feeding unit 26 or from the conveying of the band 18 caused by means of the feeding unit 26. This means, for example, that the band 18 can be conveyed by means of the feeding unit 26 and as a result can translationally conveyed through the tool 30, without influencing the straightening in an undesired manner.

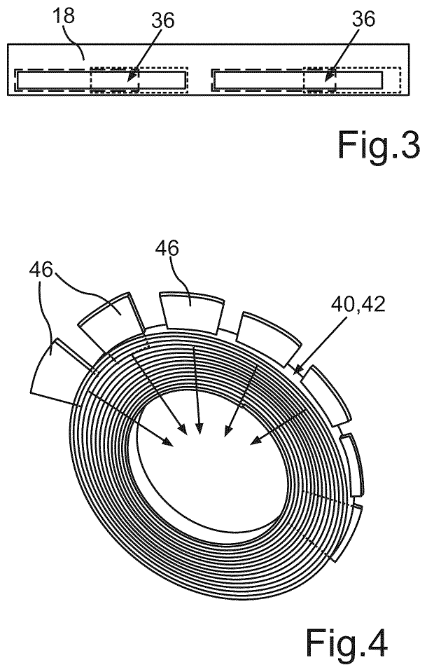

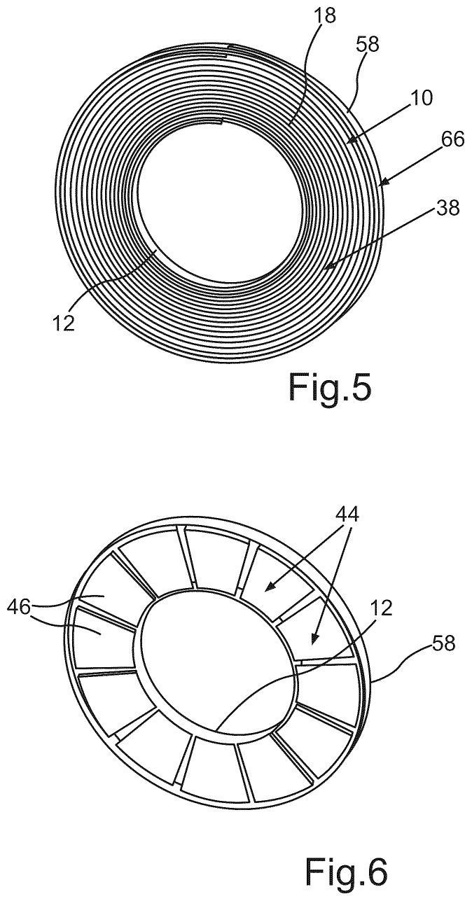

As is explained in more detail below, the band 18 is provided with through openings 36 (FIG. 3) by means of the tool 30, and thus after the unwinding from the output coil 16, after the straightening by means of the straightener device 24 and after the buffering in the buffer region 32, and is subsequently wound up to form a coil 38—which can be seen particularly clearly in FIG. 2—in such a way that each longitudinal region 40 (FIG. 4) of the band 18 forms layers 42 arranged one on top of the other in the radial direction of the rotor 10 and that the through openings 36 are arranged one on top of the other in the radial direction of the rotor 10, thereby overlapping each other and forming receptacle openings 44 (FIG. 6) also referred to as pockets or magnet pockets extending in the radial direction of the rotor 10 outwards and follow on from each other in the circumferential direction of the rotor 10 running around the axial direction of the rotor 10, and are spaced apart from each other and in particular are separated from each other. Furthermore, it is provided in the method that—as can be seen particularly well from FIGS. 4 and 6—magnets 46, which are preferably formed as permanent magnets, are arranged in the magnet pockets. As is shown in FIG. 4 by arrows, the magnets 46 are arranged in the assigned magnet pockets in such a way that the magnets 46 are moved in the radial direction of the rotor 10 and thus of the coil 38 inwards in relation to the coil 38 and are thereby moved into the magnet pockets.

The through openings 36 are produced, for example, by means of the tool 30 through shearing and/or nibbling, i.e., formed in the band 18, wherein preferably the shearing or nibbling is performed as a high-speed cutting process. The winding-up of the band 18 to form the coil 38 is also referred to as coiling. This means that the band 18 is coiled to form the coil 38 after it has been provided with the through openings 36. Before or after the coiling of the band 18 to form the coil 38, stacked lamination takes place, for example. The stacked lamination is carried out, for example, by means of a device 48 of the apparatus 14. In the embodiment shown in FIG. 7, the stacked lamination is carried out before the coiling. The stacked lamination comprises, for example, that the band 18 and thus the longitudinal regions 40 or the layers 42 are provided with an in particular liquid plastic and thus with a potting compound such that the layers 42 are laminated together by means of the plastic, i.e., connected with each other, i.e., adhesively bonded with each other. Furthermore, it is conceivable that the magnets 46 are adhesively bonded and thus connected to the band 18 i.e., to the layers 42 or the longitudinal regions 40, i.e. to the coil 38, by means of the plastic.

The apparatus 14 can have a further device 50, by means of which the magnets 46 are arranged in the magnet pockets, i.e., are moved into the magnet pockets, in particular inserted into the magnet pockets. The coiling of the band 18 to form the coil 38 is illustrated in FIG. 7 by an arrow 52. The coiling of the band 18 to form the coil 38 takes place, for example, by means of a winding unit 55 of the apparatus 14. Furthermore, for example, in particular as an alternative or in addition to the stacked lamination, the magnets 46, in particular after they have been arranged in the magnet pockets, are connected, in particular adhesively bonded, to the coil 38, i.e., to the band 18. For this purpose, the apparatus 14 has, for example, a connection device 54 by means of which, for example, a plastic functioning as an adhesive or potting compound is introduced, in particular injected, into the magnet pockets after the magnets 46 have been arranged in the magnet pockets. Therefore, the plastic, in particular in its liquid state, is injected by means of the connection device 54 towards the magnets 46 arranged in the magnet pockets and towards the coil 38, such that the plastic is injection-molded onto the magnets 46 arranged in the magnet pockets and onto the coil 38. Furthermore, the apparatus 14 comprises an electronic computing device 56 which is also referred to as a controller. The apparatus 14 is controlled and/or regulated by means of the electronic computing device 56.

During the method it is provided that the longitudinal regions 40 and thus the layers 42 are formed as one piece, in particular in such a way that the longitudinal regions 40 and thus the layers 42 are formed by the band 18 formed as one piece, for example as a metal band. In particular it is provided in the method that, while the band 18 is being provided with the through openings 36, the band 18 is moved translationally, and thus conveyed, continually along the conveying device by means of the feeding unit 26, and in particular through the tool 30 by means of which the through openings 36 are produced, i.e., are formed in the band 18.

It can be seen from FIG. 3 that each through opening 36 is completely bounded along its circumferential direction by the band 18, i.e., by a respective wall region of the band 18, which is formed as a solid body, and is thus closed. In particular it is provided that each through opening 36 is produced by nibbling.

It can be seen from FIGS. 1 and 2 that the magnet pockets in the radial direction of the rotor 10 and thus of the coil 38 are at least partially, in the present case completely, sealed inwards by means of the first, inner top layer 12. It can be seen from FIG. 1 that the top layer 12 is a ring. The top layer 12 is formed separately from the band 18 in the present case and thus separately from the longitudinal regions 40 or the layers 42. For example, the first, inner top layer 12 is produced from a first band element, formed in particular separately from the band 18, in particular by the first band element being wound up to form the inner, first top layer 12. For example, the band 18 is formed from a first material, wherein the top layer 12 can be formed from a second material which is different from the first material. FIG. 1 exhibits a first embodiment of the top layer 12. In the first embodiment, exactly one top layer is provided so that the top layer 12 has exactly one ply. However, exactly or more than two first, inner top layers could be provided. It can also be seen from FIGS. 2 and 7 that, in particular, after the production or provision of the first, inner top layer 12, the band 18 is wound up to form the coil 38 in such a way that the band 18 is wound onto the first, inner top layer 12 and thus wound around the first, inner top layer 12, whereby the longitudinal regions 40, the layers 42 and the through openings 36 form the magnet pockets (receptacle openings 44).

It can be seen from FIGS. 3 to 6 that, in particular after the winding of the band 18 to form the coil 38, the magnets 46 are arranged in the magnet pockets. The through opening 36 is produced, in particular by nibbling, in a closed cut such that, for example, the respective magnet pocket is completely surrounded by the band 18 or the coil 38 along its respective circumferential direction running around the radial direction of the rotor 10 and is thus closed.

After the magnets 46 have been arranged in the magnet pockets (receptacle openings 44), the magnet pockets are at least partially, in the present case completely, sealed towards the outside in the radial direction of the rotor 10 and thus of the coil 38 by means of an outer, second top layer 58 (FIGS. 5 and 6). The second, outer top layer 58 is also referred to as a bandage and, for example, is formed separately from the first, inner top layer 12 and separately from the band 18 or in longitudinal regions 40 and thus the layers 42. For example, the outer, second top layer 58 is or will be produced from a second band element that can be formed from a third material, different from the first material. The third material can be a material that is different from the second material, or the third material matches the second material. For example, the top layer 58 is produced in such a way, in particular from the third band element, that the top layer 58 or the second band element is wound onto the coil 38 and thus wound completely around the coil 38, in particular at least or exactly once. According to FIG. 5, exactly one top layer 58 is provided, such that the top layer 58 forms exactly one other ply or layer. It could be conceivable, however, that exactly or more than two top layers 58 are provided such that the top layer 58 has or forms exactly two or more than two layers, for example. By moving the magnets 46 in the radial direction of the coil 38 from the outside to inside the magnet pockets, the magnets 46 are inserted into the magnet pockets from the outside, so to speak.

The coil 38 and the magnets 46 arranged in the magnet pockets form a coiling unit, for example, which can comprise at least the coil 38 and the magnets 46 arranged in the magnet pockets, as well as, for example, the inner top layer 12 and/or the outer top layer 58. It is conceivable that the coiling unit and thus at least the coil 38 and the magnets 46 arranged in the magnet pockets and preferably also the inner top layer 12 and/or the outer top layer 58 are encapsulated with a plastic, in order to fixedly connect the coil 38 with the magnets 46 and preferably also with the top layers 12 and 58.

It can be seen from FIGS. 1 to 6 that, for example, each top layer 12 and 58, is, in particular completely, devoid of passage openings. At the very least, the respective top layer 12 and 58 does not have any passage openings leading into the magnet pockets or overlap the magnet pockets. As a result, the magnet pockets are completely closed by means of the top layers 12 and 58, both in a radial inward direction and in a radial outward direction when viewed individually. Particularly if the top layer 12 or 58 is formed as one piece with the band 18, it is conceivable that each top layer 12 or 58 is a respective partial region of the band 18 or a respective partial region formed in one piece with the band 18, wherein the method is carried out in such a way that the respective partial region is not provided with a through opening. This means with regard to the apparatus 14, in particular, that each partial region is moved translationally through the tool 30, for example by means of the feeding unit 26, and is thus conveyed through it, without each partial region being provided with a through opening by means of the tool 30 or another tool. Again, stated in other words, through openings are not produced in the respective partial region when the respective partial region is conveyed through the tool 30.

For example, for the respective through opening 36 by nibbling, also known as nibble cutting, produced, for example in an open cut. In this case, for example, the through openings 36 are cut in a superimposed manner. Due to the use of nibbling to produce the through openings 36, the through openings can be produced with different geometry, in particular with geometries of different lengths and thus in particular with different lengths running in the circumferential direction of the rotor 10 or the coil 38 by means of one and the same tool, in particular punching tool. Furthermore, the nibbling makes it possible to cut edge regions of the coil 38, also referred to as an electric steel sheet or forming an electric steel sheet, in order to achieve advantageous tolerances and reduced losses.

Furthermore, it is preferably provided that each through opening 36 is produced by high-speed cutting. Cutting speeds of over 10 meters per second are to be understood as high-speed cutting. In other words, it is thus preferably provided that the through openings 36 are produced by cutting and thus at a cutting speed of over 10 meters per second. Furthermore, the feeding unit 26 can be designed as a highly precise and variable feeding unit. For example, the band 18 is moved and thus conveyed translationally with a feeding rate by means of the feeding unit 26, wherein the feeding rate can be varied. In particular, the feeding rate can be adapted to a current cutting operation, in particular be controlled. A first cutting operation can, for example, comprise two quick passes in order to produce the respective through opening 36 or the respective magnet pocket. A second cutting operation can, for example, comprise producing pockets or holes or through openings 36 of different lengths, in particular on the basis of a radial diameter.

If, for example, the top layers 12 and 58 are produced in one piece with the band 18 and thus in one piece with the longitudinal regions 40 and the layers 42, the first partial section without pockets and without punching geometry is first provided and wound up to form the top layer 12, whereupon the band 18 and, in particular, the longitudinal regions 40 are wound onto the top layer 12 in such a way that the magnet pockets are formed. Subsequently, the second partial region without through openings is wound up onto the layers 42 and wound around the layers and the magnets arranged in the magnet pockets, in order to create the second, outer top layer 58 (bandage) from the second partial region. The outer, second top layer 58 is a bandaging, by means of which the magnets 46 can be held in the magnet pockets during operation of the axial flux machine and thus counter to centrifugal forces acting on the magnets 46.

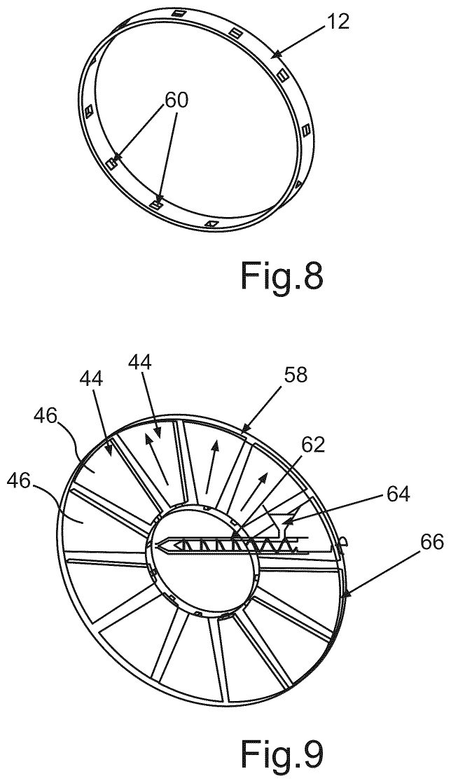

FIG. 8 illustrates a second embodiment of the first, inner top layer 12, in a schematic perspective view. It can be seen from FIG. 8 that the first, inner top layer 12 has a plurality of passage openings 60 in the second embodiment. The passage openings 60 follow each other in the circumferential direction of the coil 38 and thus the circumferential direction of the top layer 12 and are spaced apart from each other, thus in particular separated from each other, in particular by a respective wall region of the top layer 12. The respective passage opening 60 per se opens into a respective one of the magnet pockets per se, wherein the respective passage opening 60 however is formed in such a way that each magnet 46 arranged in the respective magnet pocket cannot slide inwards in the radial direction into the passage opening 60 formed as a through opening.

The aforementioned, at least the coil 38 and the magnets 46 arranged into the magnet pockets as well as preferably also the coiling unit comprising the top layers 12 and 58 can be seen in FIG. 5 and is labelled to there with 66. Thus, FIG. 5 illustrates a first embodiment of the coiling unit 66. FIG. 9 partially illustrates a second embodiment of the coiling unit 66. In the first embodiment, the inner, first top layer 12 is closed, in particular is completely closed. In the second embodiment of the coiling unit 66, the inner, first top layer 12 has the passage openings 60 (injection holes).

FIG. 9 illustrates, particularly schematically, a device 62 that is, for example, the connection device 54. Thus, for example, the device 62 is a device of the apparatus 14. By means of the device 62, the aforementioned plastic is injected through the respective passage opening 60, in particular in liquid form, and thus injected via the respective passage opening 60 into the respective magnet pocket, whereby the plastic marked with 64 in FIG. 9 is injected onto the respective magnets 46 arranged in the respective magnet pockets and onto the coil 38. By means of the plastic 64, the magnets 46 are adhesively bonded with the coil 38. Furthermore, in FIG. 9 it is indicated that when the plastic 64 is injected into the magnet pockets, the magnets 46 can be moved outwards relative to the coil 38 in the radial direction of the coil 38. The second, outer top layer 58 (bandage) thus forms an abutment for the magnets 46 arranged in the magnet pockets, such that the magnets 46 do not slide or are not conveyed out of the magnet pockets outwards in the radial direction.

For example, the plastic 64 is injected into the respective magnet pocket by injection molding and thus injection-molded towards the coil 38 and the respective magnet 46 and in other words, for example, the aforementioned injection molding is carried out by means of the device 62. The respective passage opening 60 is an injection hole or is also referred to as an injection hole, wherein the injection holes can be produced particularly advantageously by the nibbling. Thus, it is particularly conceivable that the passage openings 60 are produced by means of the apparatus 14 and in particular by means of the tool 30 and thus preferably by the nibbling, i.e., formed in the inner, first top layer 12. During or due to the injection of the plastic 64 into the magnet pockets, the magnets 46 are pressed outwards onto the outer bandage (top layer 58) in the radial direction, whereby the magnets 46 are particularly advantageously fixed.

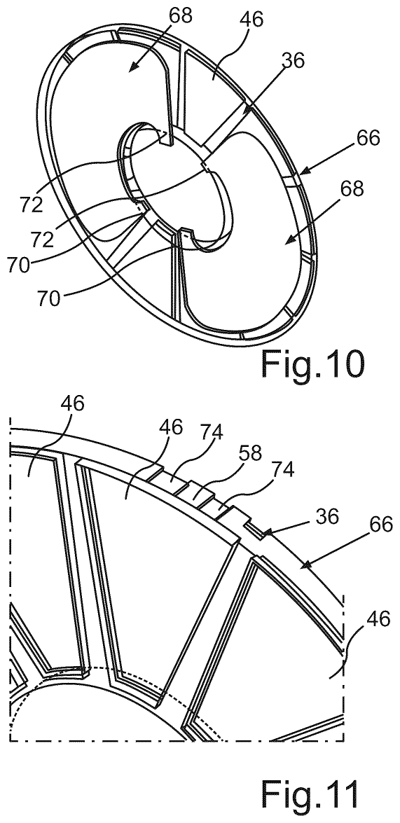

FIG. 10 illustrates a third embodiment of the coiling unit 66. In the third embodiment, it is provided that, in particular of the device 14, and more particularly by means of the tool 30, the band 18 and thus the longitudinal regions 40 or the layers 42 are or will be provided with further through openings, in particular by nibbling, in such a way that the further through openings form cooling channels 68, in particular when the band 18 is wound up to form the coil 38. It can be seen from FIG. 10 that the respective cooling channel 68 has a respective inlet 70, by which a preferably liquid cooling medium can be introduced into the respective cooling channel 68. Furthermore, the respective cooling channel 68 has a respective outlet 72, by which the respective cooling medium can be extracted from the respective cooling channel 68. The coil 38 can be cooled by means of the cooling medium flowing through the respective cooling channel 68.

Finally, FIG. 11 illustrates a fourth embodiment of the coiling unit 66. In the fourth embodiment, negative balancing of the coiling unit 66 and in particular of the second, outer top layer 58 (bandage) is provided. Negative balancing means that, for example, by means of the apparatus 14, and very particularly by means of the tool 30, material is preferably removed, in particular separated off, from the outer top layer 58 by the aforementioned nibbling, whereby, for example, balancing pockets 74 are produced. As a result, the coiling unit 66 is balanced. For example, an imbalance, in particular of the coiling unit 66, is measured at least essentially continuously, for example on or by means of a reel, by means of which, for example, the band 18 is wound up to form the coil 38.

Depending on the measured imbalance, the negative balancing is carried out in such a way that the second, outer top layer 58 (bandage) is processed by nibbling, i.e., is nibbled out.

In an embodiment not shown, further apertures can be made in the center of the band 18 in addition to the receptacle openings 44 for the magnets 46. These apertures in the band 18 are then arranged congruently in layers 42 arranged one on top of the other when the band 18 is wound up, in order to form an integrated channel in the rotor 10 extending radially through the layers 42. Such a channel can then be used as a cooling channel, in order to cool the rotor 10 by flooding it with a medium, in particular a fluid. For this purpose, inlets and outlets of the cooling channel are required, which are either directly radially on the inside and on the outside in the case of continuous cooling channels through all the layers 42. It can also be the case, however, that the cooling channel does not penetrate all of the layers 42, in particular when the inner and outer layers 42 do not have additional apertures, such that lateral access can be created via holes. This also enables lateral flooding of such an integrated radial cooling channel. A mixed form of such a cooling channel is also possible, in which it runs either only radially inwards or only radially outwards and therefore a lateral inlet or outlet opening must be created on the side opposite the opening.

Alternatively, such a lateral opening can be created directly during the production of the apertures by also removing the band on the side of some of the apertures centered in the band 18, so that the apertures then appear as recesses in the band 18. During winding, the apertures designed as recesses then form the lateral openings of the remaining integrated radial cooling channel represented by the apertures per se. The advantage of this would be the elimination of the further processing step of creating, in particular boring, the lateral accesses to the cooling channels, but the handling of the band 18 weakened by the recesses is likely to be somewhat more difficult.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 Rotor
12 First top layer
14 Apparatus
16 Output coil
18 Band
20 Reel
22 Arrow
24 Straightener device
26 Feeding unit
28 Arrow
30 Tool
32 Buffer region
34 Strap
36 Through openings
38 Coil
40 Longitudinal region
42 Layer
44 Receptacle opening
46 Magnet
48 Device
50 Further device
52 Arrow
54 Connection device
55 Winding unit
56 Electronic computing device
58 Second top layer
60 Passage opening
62 Device
64 Plastic
66 Coiling unit
68 Cooling channel
70 Inlet
72 Outlet
74 Balancing pocket

1-12. (canceled)

13. A method for producing a rotor for an electric machine, the method comprising:
producing a band with through openings by nibbling;
winding the band up in such a manner that each longitudinal region of the band forms layers arranged one on top of another in a radial direction of the rotor and in such a manner that the through openings are arranged one on top of the other in the radial direction of the rotor to form receptacle openings widening outwards in the radial direction of the rotor and spaced apart from each other in succession in a circumferential direction of the rotor, wherein magnets are arranged in the receptacle openings,
wherein the layers of the band are inductively bonded in-line after manufacturing the receptacle openings for the magnets and before each magnet is arranged in a respective receptacle opening in such a way that each magnet is moved in the radial direction of the rotor from an outside to an inside in relation to the layers and is thus moved into the respective receptacle opening and after the respective magnet is arranged in the respective receptacle opening, each magnet is connected to the band by a plastic that is injection-moulded onto the band and the respective magnets.

14. The method of claim 13, wherein between the winding up of the band and the arrangement of the magnets in the receptacle openings, there is no unwinding of the wound-up band and no subsequent rewinding of the band.

15. The method of claim 13, wherein the longitudinal regions and the layers are formed with each other as one piece.

16. The method of claim 13, wherein the band is moved translationally continually along a conveying direction while the band is being provided with the through openings and is conveyed thereby.

17. The method of claim 13, wherein the receptacle openings are sealed at least partially in the radial direction of the rotor towards the inside or outside by at least one top layer.

18. The method of claim 17, wherein the top layer (12, 58) is formed as one piece.

19. The method of claim 17, wherein
the top layer is formed as one piece with the layers of the band, or
the top layer is formed by a band element formed separately from the layers of the band.

20. The method of claim 13, further comprising:
forming apertures in a center of the band, wherein when the band is wound up into layers arranged one on top of the another, the apertures are arranged congruently and form an integrated cooling channel in the rotor extending radially through the layers of the band.
